(19) United States
(12) Patent Application Publication
(10) Pub. No.: US 2023/0204763 A1
(43) Pub. Date: Jun. 29, 2023

(54) RADAR MEASUREMENT COMPENSATION TECHNIQUES

(71) Applicant: TUSIMPLE, INC., San Diego, CA (US)

(72) Inventor: Chiyu ZHANG, San Diego, CA (US)

(21) Appl. No.: 18/084,294

(22) Filed: Dec. 19, 2022

Related U.S. Application Data
(60) Provisional application No. 63/266,170, filed on Dec. 29, 2021.

(51) Int. Cl. G01S 13/931; G01S 13/58

(52) U.S. Cl. CPC G01S 13/931; G01S 13/582

(57) ABSTRACT

Disclosed are devices, systems and methods for compensating radar measurements of a vehicle. One exemplary method includes generating a set of velocity hypotheses of a target object based on a first measurement data obtained from sensors mounted on the vehicle; generating cluster velocity estimates by applying a clustering algorithm to a second measurement data obtained from the sensors; and providing one or more selected velocity hypotheses from the set of velocity hypothesis as compensated radar measurements for the target object based on the cluster velocity estimates.

### PRIORITY CLAIMS AND RELATED PATENT APPLICATIONS

This patent document claims the priority to and the benefits of U.S. Provisional Application No.: 63/266,170 entitled “RADAR MEASUREMENT COMPENSATION TECHNIQUES” filed on Dec. 29, 2021. The entire disclosure of the aforementioned application is hereby incorporated by reference as part of the disclosure of this application.

### TECHNICAL FIELD

This document relates to tools (systems, apparatuses, methodologies, computer program products, etc.) for semi-autonomous and autonomous control of vehicles, and more particularly, a radar measurement compensation for autonomous vehicles.

### BACKGROUND

Autonomous vehicle navigation is a technology for sensing the position and movement of a vehicle and, based on the sensing, autonomously controlling the vehicle to navigate towards a destination. Autonomous vehicle navigation can have important applications in transportation of people, goods and services. In order to ensure the safety of the vehicle, as well as people and property in the vicinity of the vehicle, autonomous algorithms implemented by these applications, various measurement data is obtained.

### SUMMARY

Disclosed are devices, systems and methods for compensating ambiguity in radar measurements of autonomous vehicles. The suggested technology can be applied to compensate velocity measurements of radar measurements.

In one aspect, the disclosed technology can be used to provide a method for compensating radar measurements of a vehicle. The exemplary method includes generating a set of velocity hypotheses of a target object based on a first measurement data obtained from sensors mounted on the autonomous vehicle; generating cluster velocity estimates by applying a clustering algorithm to a second measurement data obtained from the sensors; and providing one or more selected velocity hypotheses from the set of velocity hypothesis as compensated radar measurements for the target object based on the cluster velocity estimates.

In another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed.

The above and other aspects and features of the disclosed technology are described in greater detail in the drawings, the description and the claims.

### BRIEF DESCRIPTION OF THE DRAWINGS

FIG. 1 shows an example of a schematic diagram showing a radar system applied to a vehicle.

FIG. 2 shows an example of incorrect radar measurements.

FIG. 3A shows an example screen that illustrates an ambiguity free velocity range in radar measurements and FIG. 3B shows an example of a graph that illustrates a need for a compensation to reduce or remove ambiguity in radar measurements.

FIG. 4 shows an example of a measurement compensation system based on some implementations of the disclosed technology.

FIG. 5 provides an example of a testing result obtained based on some implementations of the disclosed technology.

FIG. 6 provides another example of a testing result obtained based on some implementations of the disclosed technology

FIG. 7 shows an example of a hardware platform that can implement some techniques described in the present document.

FIG. 8 is a flowchart of an exemplary method for the operational testing of an autonomous vehicle, in accordance with embodiments of the disclosed technology.

### DETAILED DESCRIPTION

The transportation industry has been undergoing considerable changes in the way technology is used to control the operation of the vehicles. An autonomous vehicle is provided with a radar (radio detection and ranging) system to enable a vehicle to operate in a partially or fully autonomous mode. The radar system uses radar sensors to capture data regarding an environment through which the autonomous vehicle traverses and use this data to detect information about target objects in the environment to avoid collisions. For example, the radar system may measure the distance between the vehicle and another vehicle navigating in front of the vehicle and the radar data is used to determine control operations, such as route navigation, speed control, and obstacle avoidance. Various implementations of the disclosed technology provide a system and a method for providing more accurate radar measurements by compensating ambiguity in radar measurements. The measurements compensated by using the disclosed technology may include velocity measurements that are obtained from the radar system, for example, radar sensors. The suggested technique can be applied to the radar system provided at various positions of the vehicle, for example, a front, a rear, and/or a side of the vehicle. Although the radar sensors are discussed in this patent document as providing the radar measurements, the suggested technology can be implemented using any other sensors that generate range-doppler measurement from RF waves.

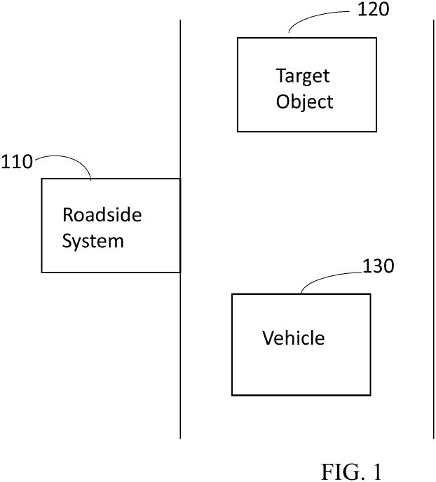

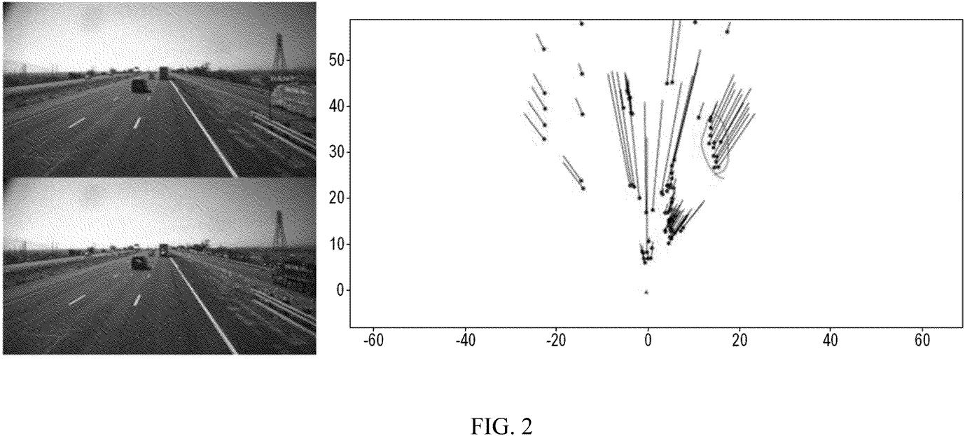

FIG. 1 shows an example of a schematic diagram that illustrates a vehicle obtaining radar measurement to determine a velocity of a target object. A vehicle 130 includes a vehicle-mounted radar system configured to detect the target object 120 in front of the vehicle 130. A roadside system 110 is provided on a side of a road and configured to collect environment information including the target object 120 and the vehicle 130. The roadside system 110, the target object 120 and the vehicle 130 are in communication with one another and configured to exchange various data. The radar system mounted in the vehicle 130 is configured to detect the target object 120 using radar technologies. For example, the radar system may be configured to receive, while the vehicle 130 is moving on a road of travel, radar measurement acquired from one or more radar sensors mounted on the vehicle 130. The radar system may then use the radar measurements to detect the target object 120. The radar sensor measures distances, movements, and/or velocity and the radar system can provide range information using pulse delay, velocity information using Doppler frequency shift, and/or angular direction using antenna pointing. The radar sensors are configured to receive the reflected RF signal that each radar sensor transmits, and the radar system can provide: range from the signal transmitting/receiving delay; angular direction from the signal phase difference between multiple receiving antennas; velocity from the doppler frequency shift and/or internal tracking algorithm; and RCS (radar cross section) from the amplitude of the received signal. In the example, as the radar measurements, the velocity measurements of the target object 120 are detected using the radar system mounted in the vehicle 130. The term, velocity, may refer to a linear velocity and/or an angular velocity. Further, the term, velocity, may be a scalar quantity such as speed or a vector quantity, such as speed and angle.

It has been observed that conventional radar systems sometimes provide incorrect or ambiguous velocity measurements especially when the target object 120 is at relatively high speeds. The incorrect or ambiguous velocity measurements on high speed target objects limit the velocity measuring capability of the radar detection and make the radar system not suitable for highway scenarios when vehicles move on relatively high speeds. For example, when the speed of a target object relative to an ego vehicle is expected to be a negative value, a positive speed can be detected. Such detection is considered incorrect. Because when the target object is a static object on the roadside in the direction of the ego vehicle traveling, such as a parked vehicle or a traffic sign, the target object is expected to have a negative value of the speed relative to the ego vehicle as the ego vehicle is approaching the static object. Such incorrect or ambiguous measurements can be caused by the physical nature of the radars. As an automatic driving is getting popular, there have been much efforts to improve an accuracy of radar measurements and apply the radar measurement techniques to relatively high speed scenarios.

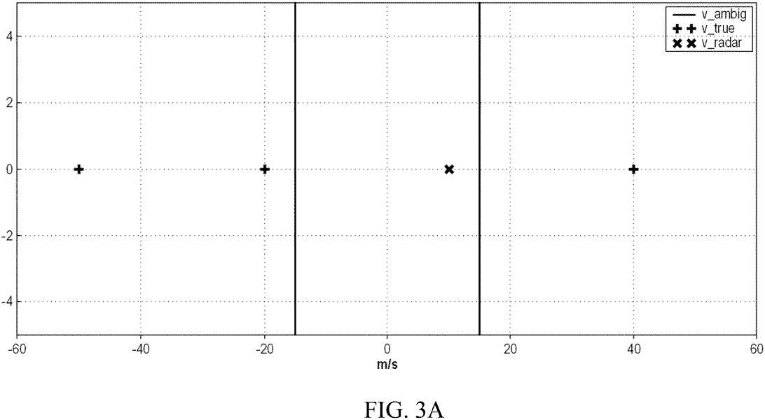

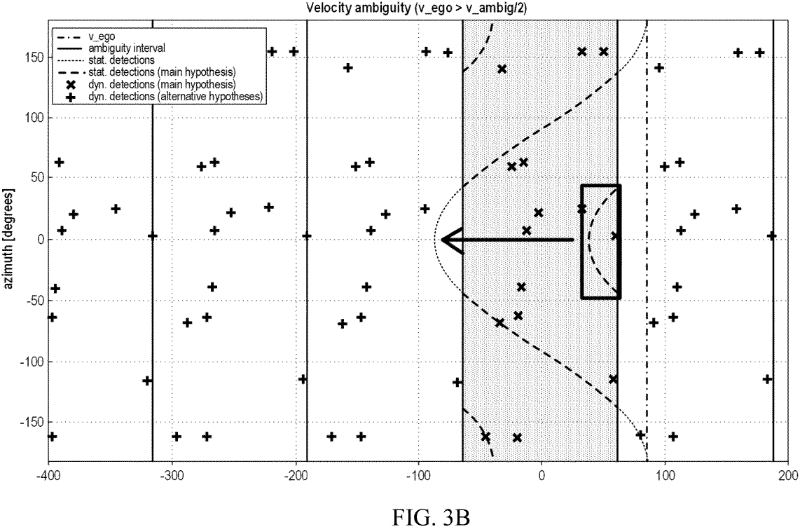

FIG. 2 shows an example of incorrect radar velocity measurements that are obtained from a conventional radar system. While there can exist various causes for the incorrect radar measurements, the Doppler ambiguity is discussed as the example of the cause. Pulse-Doppler and modulated continuous wave radar transmits a pulse train of chirps (pulses of linearly increasing or decreasing frequency) and estimates range to a target by estimating time of flight and estimates speed of a target by estimating Doppler frequency, which corresponds to the shift in frequency between transmitted pulses and resulting reflections. The Doppler ambiguity causes ambiguity in radar velocities. In the example of FIG. 2, the positive speed detection (for example, see the circled portion in FIG. 2) is obtained when the actual environment corresponds to the negative velocity detection. In FIG. 2 each dot represents a detection generated by the radar system and the solid line indicates the speed direction and magnitude of the detection. The circled portion includes the radar detections from the static vehicle at the road side in the camera image. It is expected that the ego vehicle is moving towards any static vehicles at the road side at the direction where the ego vehicle is heading. The radar measurements of the static vehicles in the view shown in FIG. 2 are expected to be negative values. However, due to the Doppler ambiguity, the radar measurements of the static vehicles are erroneously detected as possible values. The radar detection speed incorrectly shows the road side vehicle is moving away from the ego vehicle due to the velocity ambiguity. The cause of the ambiguity is explained in FIGS. 3A and 3B in more detail.

FIG. 3A shows an example screen that illustrates an ambiguity free velocity range of radar measurements and FIG. 3B shows an example of a graph including radar measurements that are needed to be compensated.

Referring to FIG. 3A, the ambiguity free velocity range is a velocity range that is considered free from the ambiguity. The ambiguity free velocity range is predetermined based on a pulse repetition frequency (PRF) of a radar signal. The pulse repetition frequency is the number of pulses of a repeating signal in a specific time unit, normally measured in pulses per second. In pulse radars, the modulation of the carrier frequency is a periodic sequence of rectangular pulses. While electromagnetic waves travel with the speed of light, it takes a given receiving time for the pulse radar to detect far away objects. If an inter-pulse period is long enough, no problem occurs. When the inter-pulse period is shortened, the time to the last previous pulse is shorter than the actual time needed and an ambiguous shorter range can occur. Long range radars can operate with a low PRF. Doppler radars are capable of measuring a range of velocities unambiguously. The ambiguity free velocity range can indicate that the values of the speed measurements occurring within this range are not affected by the radar ambiguity. For example, the ambiguity free velocity range is determined as +- 15 m/s (v_ambig =30). The two solid line marks at -15 m/s and at 15 m/s define the ambiguity free velocity range. In the example of FIG. 3A, the ambiguity free velocity range (v _ambig) is 30 and the points with true speed (v_true) at -50 m/s, -20 m/s, 10 m/s, 40 m/s can all appear as 10 m/s in the radar output (v_radar). Finding values of a true speed of a vehicle based on a radar output can be done by using a signal processing technique.

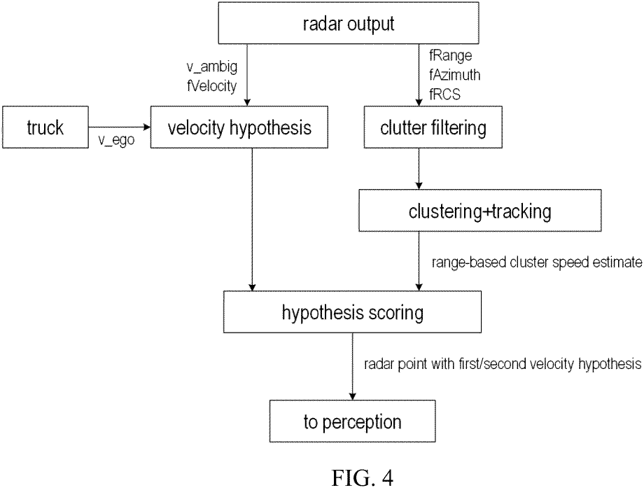

The example graph as shown in FIG. 3B can be provided from a computing unit of a vehicle or a remote system. When the ambiguity free velocity range is 30 m/s (v_ambig = 30), when the velocity measurements are outside the ambiguity free velocity range, the computing unit outputs the speed to the other side of the screen. For v_ambig= 30, any detection point with a radial speed greater than 15 m/s or less than -15 m/s will be folded into the range of -15 m/s to 15 m/s. The dashed lines at the upper left corner, at the lower left corner, and at the middle of the right side of the grayed ambiguity free velocity range show the area where the detection points are folded. This folded response occurs as long as a radar measurement is outside a predetermined ambiguity free velocity range regardless of egomotion information of a vehicle (v_ego) that is static or moving. In the example of FIG. 3B, the dotted portion corresponds to the speed that is outside the ambiguity free velocity range and the box indicates the folded response that is output to the other side of the screen. The speed output to the other side of the screen corresponds to folded speed detection. Thus, the speed information included in the box has velocity ambiguity and needs to be compensated. The arrow in FIG. 3B shows the desired compensation for the incorrect radar measurements indicated in the box. The measurements that are shown as folded in FIG. 3B can be adjusted by a measurement compensation system shown in FIG. 4 below.

FIG. 4 shows an example of a measurement compensation system based on some implementations of the disclosed technology. The measurement compensation system includes a velocity hypothesis module, a clutter filtering module, a clustering and tracking module, and a hypothesis scoring module. The measurement compensation system as shown in FIG. 4 can be provided in a vehicle and used to detect a target object. In FIG. 4, a truck is shown as an example of an autonomous vehicle but the disclosed technology is not limited thereto. For example, the measurement compensation system may be implemented in other vehicles, such as cars, motorcycles, buses, boats, airplanes, or robot devices.

The truck is configured to provide egomotion information of the truck (v_ego) to the velocity hypothesis module of the measurement compensation system. In some implementations, the egomotion information is related to the 3D motion of the truck within an environment relative to a scene and obtained using at least one sensor (e.g., positioning/motion sensors, an image sensor, a distance sensor, and combinations thereof) or a wheel encoder. For example, the positioning/motion sensors may be provided as a Global Navigation Satellite System (GNSS)-Inertial Measurement Unit (IMU) package and the egomotion information can be obtained by processing the sequence of GNSS-IMU signals. For example, the sensor is an image sensor such as a camera and the egomotion information is determined by processing a sequence of images taken by the camera. For example, the wheel velocity can be directly read from the wheel encoder. This egomotion information can be used to determine the movement of the truck. The velocity hypothesis module is configured to receive, from the truck, (1) the egomotion information from the truck and further receive, from the radar system mounted on the truck, radar output that includes (2) velocity measurement information such as the ambiguity free velocity range (v_ambig) and/or velocity information (fvelocity), and (3) range measurement information such as range, azimuth and/or RCS (radar cross section) information for the cluttering and clustering. The velocity hypothesis module receives the above items (1) to (3) and the measurement compensation system is configured to compensate the item (2) to be discussed below. In the example, the range measurement information is provided as a point chart of radar measurements.

The velocity hypothesis module is further configured to generate velocity hypothesis (vh) based on the received egomotion information and the received radar output, e.g., the velocity measurement information. To generate the velocity hypothesis, a ground speed range is predetermined and provided to the velocity hypothesis module. The velocity measurement information can be combined with a chart showing velocity outputs and the catalyst from other sources, for example, optometry and other speed measurements that are available on the chart.

In the example case, when v_ego = 20 (i.e., the speed of the ego vehicle) and the ground speed range is [-50, 50], the velocity hypothesis module derives the relative speed range as [-70, 30]. The relative speed range corresponds to the range of the speed of the truck with respect to the ground speed range. When the radar output provides v_ambig=30 (i.e., ambiguity free velocity range) and fVelocity = 10, the velocity hypothesis module generates velocity hypotheses, e.g., [-50, -20, 10, 40]. As explained earlier, speed measurements at the values of -50, -20, 10, and 40 can appear as the value of 10 in radar outputs given the ambiguity free velocity range being 30. This is because the output is equal to a summation of each raw range rate (i.e. -50, -20, 10, and 40) and the ambiguity free velocity range multiplied by n. For example, -50 plus 30*n (n being 2) is equal to 10. The velocity hypothesis module generates the velocity hypotheses following the same relationship mentioned above.

The clutter filtering module is applied to the radar output to remove low RCS points as they usually belong to ground reflection. The ground reflection can be one of the contributors to measurement uncertainty in characterization of RCS of automotive objects. The radar signal includes the clutter signal that is generally with low-amplitude and random occurrence. The clutter signal is an obstacle to detect the target object and thus the clutter filtering is performed to remove the clutter signal from the radar output. The clutter filtering can correspond to the first step of the radar data processing. The clutter filtering module can employ various filtering algorithms to eliminate undesired clutter interferences.

The clustering and tracking module is configured to receive the filtered radar output from the clutter filtering module and generate cluster velocity estimates. The operations of the clustering and tracking module can correspond to the second step of the radar data processing that is performed subsequent to the first step, i.e., the clutter filtering. The clustering and tracking module is configured to cluster the filtered radar output such that the filtered radar output is clustered as groups, a group of data sharing common features, such as overlapping data, shared statistical properties, etc. While the radar output can provide, for example, hundreds of points per frame, the clustering can create, for example, tens of clusters per frame from the radar points, thus improving the efficiency by matching the clusters instead of the points frame-by-frame to determine the velocity of the target object. The clustering and the tracking module can employ various data clustering algorithms. For example, the clustering and the tracking module performs the clustering via DBSCAN (density-based spatial clustering of applications with noise) using a position weighted by RCS. To improve the clustering resolution, the radar field of view (FOV) is divided in multiple areas based on the y values and performs DBSCAN for each area. In some implementations, the clustering and tracking module generates the cluster velocity estimates based on a range difference of matched clusters in two frames.

In addition, the clustering and tracking module is configured to perform the cluster tracking by applying various algorithms. For example, the tracking algorithm may comprise two parts, which include a data association and a state estimation. For example, the nearest-neighbour association (Munkres) can be employed for the data association to match the clusters between sequences of frames. For example, extended Kalman filter (EKF) can be employed for the state estimation to provide the cluster position/velocity estimates. The velocities of a tracked cluster (vc), i.e., a cluster that is associated with the previous cluster is directly provided by the state estimation algorithm. The velocities are calculated based on a distance difference between the associated clusters in two frames. For the un-tracked clusters that appear for the first time (i.e., not associated with any previous clusters), an initial guess of velocity is used. It has been observed that the radar system often generates a few measurement points from a vehicle target, typically below 10 points. Thus, only the small-sized clusters are considered as moving targets and tracked, while the big ones are considered as static (i.e., vc=-v_ego). After the clustering and tracking operations, the clustering and tracking module provides range and velocity estimates as its outputs.

The hypothesis scoring module is configured to receive velocity hypotheses output from the velocity hypothesis module and the range-based cluster velocity estimates output from the clustering and tracking module. The hypothesis scoring module compares the range-based cluster velocity estimates that are output from the clustering and tracking module with the velocity hypotheses that are output from the velocity hypothesis module. The hypothesis scoring module scores each velocity hypothesis while the score of a velocity hypothesis provides information as to how most likely that velocity hypothesis is considered as correct. In some implementations, for all radar points, the score of each of its velocity hypothesis (vh) is calculated using a predefined algorithm. In the specific example, the predefined algorithm uses the following equation: (vh-vc)⁻², where vc is the velocity of a cluster which the radar point belongs to and vh is the velocity hypothesis. If the radar point does not belong to any cluster (isolated point), it is considered as static, i.e., vh=-v_ego. The hypothesis scoring module is designed to provide a predetermined number of hypotheses as its output. In the example, two hypotheses with the first highest scores and the second highest scores are output from the hypothesis scoring module. It is appreciated that the selection of the optimal hypotheses is not limited to selecting the first and the second highest scores, more or less hypotheses can be selected based on the scores.

The hypothesis scoring module has been explained as the example algorithm/element that determines an output of the measurement compensation system by scoring each velocity hypothesis based on the range-based cluster velocity estimates output from the clustering and tracking module. However, the hypothesis scoring module is the example only and various other algorithms/elements can be applied to the measurement compensation system as to which hypothesis is to be selected as its output and as to how the range-based cluster velocity estimates output is utilized. The measurement compensation system is configured to provide its output as compensated radar measurement by using the clustering algorithm to generate cluster velocity estimates based on the range difference of matched clusters in two frames. With the suggested compensation techniques, it is possible to avoid and remove incorrect or ambiguous radar measurements, which allows in real time to obtain more accurate radar measurements.

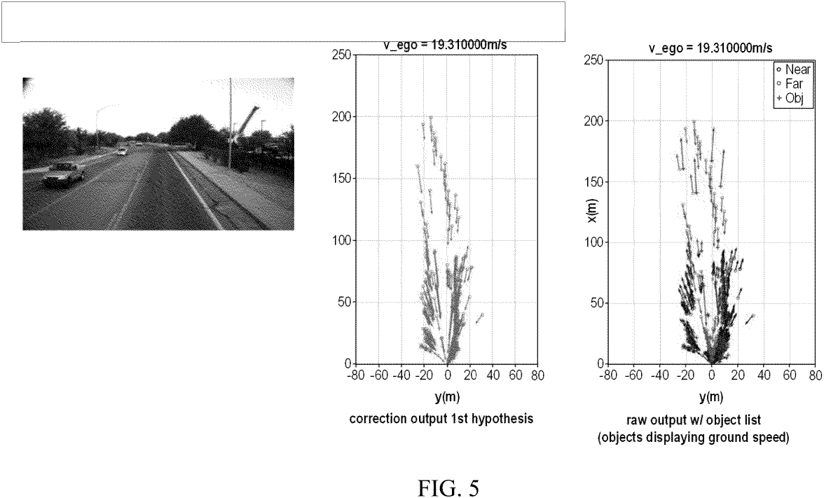

The testing results show the proposed techniques are feasible and provide improved accuracy for the radar measurements. The suggested compensation technique is implemented in real-time for the testing. FIG. 5 provides an example of a testing result obtained based on some implementations of the disclosed technology. In FIG. 5, the graph on the right shows the raw velocity output before the correction and the graph on the left shows the corrected velocity output after the correction. The corrected velocity output corresponds to the output from the testing using the suggested techniques as discussed in this patent document. The direction of the arrows in the left and right testing results represents the velocity direction and the length of the arrow represents the scale of the velocity. As compared to the raw velocity output where some arrows are facing upward, the corrected velocity output includes those arrows that have changed direction facing downward. In the graph on the right showing raw velocity outputs, the arrows facing upward indicate speed measurements with positive values, some of which are considered incorrect because they are expected to be negative values. As explained earlier, the relative speed of the static object on the road side in the direction of the ego vehicle traveling is expected to be negative as the ego vehicle is approaching the static object. After the correction, some of the upward facing arrows in the graph of raw velocity outputs are corrected to be downward facing arrows in the graph showing the corrected velocity outputs. Since the most left screen shows the environment in which all vehicles are driving forward, the corrected velocity output provides more accurate velocity information as compared to the raw velocity output.

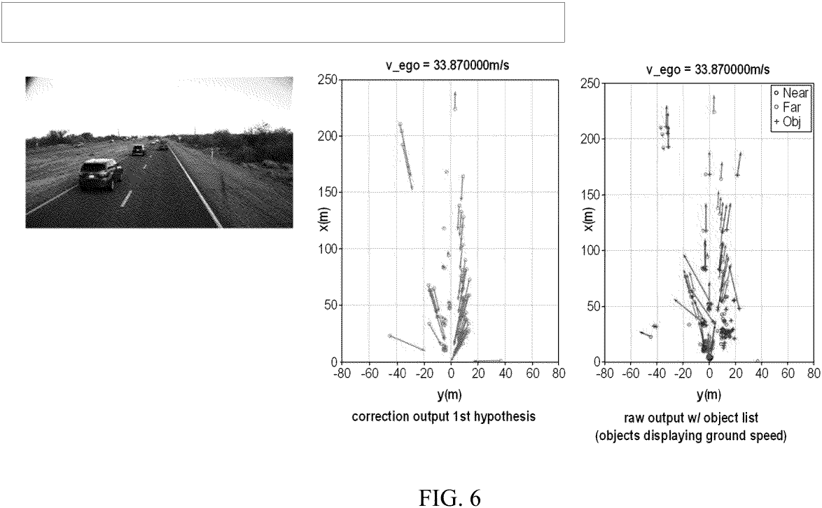

FIG. 6 provides another example of a testing result based on implementations of the disclosed technology. The suggested compensation technique is implemented in real-time for the testing. In FIG. 6, the right graph shows the raw velocity output before the correction and the left graph shows the corrected velocity output after the correction. The corrected velocity output corresponds to the output from the testing using the suggested techniques as discussed in this patent document. The direction of the arrows in the left and right testing results represents the velocity direction and the length of the arrow represents the scale of the velocity. As compared to the raw velocity output where some arrows are facing upward, the corrected velocity output includes those arrows that are downward facing. Since the most left screen shows the environment in which all vehicles are driving forward, the corrected velocity output provides accurate velocity information compared to the raw velocity output.

The suggested techniques can be implemented using machine learning/artificial intelligence (AI) applications that perform various types of data analysis to automate analytical model building. For example, the machine learning/AI applications employ algorithms to evaluate feedback data from the measurement compensation system and suggest recommendations for the implementation of the measurement compensation system. For example, the machine learning/AI applications employ algorithms to apply to generate a velocity hypothesis and/or cluster the radar points and also make suggestions for an optimized equation for scoring the velocity hypothesis. The machine learning/AI applications consider various real time conditions such as: how many vehicles exist on the road, any weather conditions that can affect to the radar measurements, etc. By applying the machine learning/AI applications to the measurement compensation techniques suggested in this patent document, it is possible to continue improving the algorithms of the measurement compensation technique to further reduce ambiguity in radar measurements obtained from the vehicle.

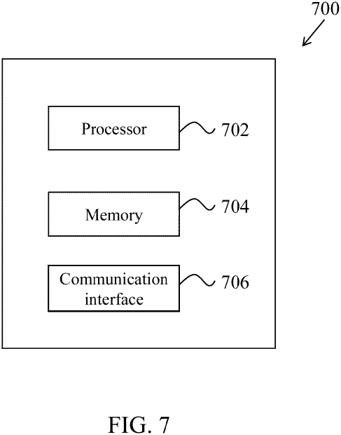

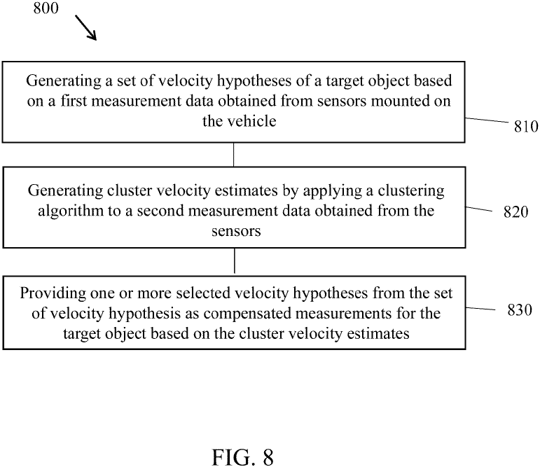

FIG. 7 shows an example of a hardware platform 700 that can be used to implement some of the techniques described in the present document. For example, the hardware platform 700 may implement the method, for example, as shown in FIG. 8 or may implement the various modules described herein. The hardware platform 700 may include a processor 702 that can execute code to implement a method. The hardware platform 700 may include a memory 704 that may be used to store processor-executable code and/or store data. The hardware platform 700 may further include a communication interface 706. For example, the communication interface 706 may implement automotive ethernet and/or controller area network (CAN bus).

FIG. 8 is a flowchart of an exemplary method for compensating measurements. The method 800 includes, at the step 810, generating a set of velocity hypotheses of a target object based on a first measurement data obtained from sensors mounted on a vehicle. The method 800 further includes at the step 820, generating cluster velocity estimates by applying a clustering algorithm to a second measurement data obtained from the sensors. The method 800 further includes, at the step 830, providing one or more selected velocity hypotheses from a set of velocity hypothesis as compensated measurements for the target object based on the cluster velocity estimates. Although not shown, the method may further includes determining scores of each velocity hypothesis based on the cluster velocity estimates, and the one or more selected velocity hypotheses are provided based on the scores.

Embodiments of the disclosed technology include a device for compensating measurements of a vehicle that includes a processor and a memory that comprises instructions stored thereupon, wherein the instructions when executed by the processor configure the processor to generate a set of velocity hypotheses of a target object based on a first measurement data obtained from sensors mounted on a vehicle; generate cluster velocity estimates by applying a clustering algorithm to a second measurement data obtained from the sensors; and provide one or more selected velocity hypotheses from the set of velocity hypothesis as compensated measurements for the target object. The instructions further configure the processor to compare the cluster velocity estimates with the set of velocity hypotheses to determine scores of each velocity hypothesis, and wherein the one or more selected velocity hypotheses are provided based on the scores.

Embodiments of the disclosed technology include a non-transitory computer-readable program storage medium having instructions stored thereon, the instructions, when executed by a processor, causing the processor to perform a method comprising: generating a set of velocity hypotheses of a target object based on a first measurement data obtained from sensors mounted on a vehicle; generating cluster velocity estimates by applying a clustering algorithm to a second measurement data obtained from the sensors; and providing one or more selected velocity hypotheses from the set of velocity hypothesis as compensated measurement data of the target object. The method may further include determining scores of each velocity hypothesis based on the cluster velocity estimates, and the one or more selected velocity hypotheses are provided based on the scores.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for compensating radar measurements of a vehicle, comprising:
generating a set of velocity hypotheses of a target object based on a first measurement data obtained from sensors mounted on the vehicle;
generating cluster velocity estimates by applying a clustering algorithm to a second measurement data obtained from the sensors; and
providing one or more selected velocity hypotheses from the set of velocity hypothesis as compensated radar measurements for the target object based on the cluster velocity estimates.

2. The method of claim 1, wherein the first measurement data corresponds to velocity measurements obtained from the sensors and the second measurement data corresponds to range measurements obtained from the sensors.

3. The method of claim 1, further comprising, prior to the generating of the cluster velocity estimates: applying a clutter filtering to the second measurement data obtained from the sensors.

4. The method of claim 1, further comprising: determining scores of each velocity hypothesis in the set of velocity hypotheses based on the cluster velocity estimates, and wherein the one or more selected velocity hypotheses are provided based on the scores.

5. The method of claim 1, wherein the set of velocity hypothesis is generated based on a relative speed range that is derived based on egomotion information of the vehicle.

6. The method of claim 1, wherein the generating of the cluster velocity estimates comprises:
applying the clustering algorithm to cluster points in a frame provided as the second measurement data; and
applying a tracking algorithm to each cluster to generate the cluster velocity estimates.

7. The method of claim 1, wherein the cluster velocity estimates are generated based on a range difference of matched clusters in two frames that are provided as the second measurement data.

8. The method of claim 1, wherein the cluster velocity estimates are generated by applying density-based spatial clustering of applications with noise (DBSCAN) using a position weighted by radar cross section of the target object.

9. The method of claim 4, wherein an artificial intelligence algorithm is applied to at least one of the generating of the cluster velocity estimates and the determining of the scores of each velocity hypothesis.

10. The method of claim 4, wherein the determining of the scores of each velocity hypothesis calculates the scores based on a difference between a velocity of a cluster to which a radar point belongs to and a velocity hypothesis.

11. A system for compensating radar measurements of a vehicle, comprising:
a processor; and
a memory that comprises instructions stored thereupon, wherein the instructions, when executed by the processor, configure the processor to:
generate a set of velocity hypotheses of a target object based on a first measurement data obtained from sensors mounted on the vehicle;
generate cluster velocity estimates by applying a clustering algorithm to a second measurement data obtained from the sensors; and
provide one or more selected velocity hypotheses from the set of velocity hypothesis as compensated radar measurements for the target object based on the cluster velocity estimates.

12. The system of claim 11, wherein the second measurement data is provided as a point chart showing points in frames.

13. The system of claim 11, wherein the generating of the cluster velocity estimates comprises:
applying the clustering algorithm to cluster points in a frame provided as the second measurement data; and
applying a tracking algorithm to each cluster to generate the cluster velocity estimates.

14. The system of claim 13, wherein the clustering algorithm corresponds to a density-based spatial clustering of applications with noise (DBSCAN).

15. The system of claim 13, wherein the tracking algorithm corresponds to a nearest-neighbour association along with an extended Kalman filter estimation.

16. The system of claim 13, wherein the instructions further configure the processor to compare the cluster velocity estimates with the set of velocity hypotheses to determine scores of each velocity hypothesis, and wherein the scores of each velocity hypothesis provides information as to how most likely a corresponding velocity hypothesis is considered as correct.

17. The system of claim 13, wherein the system is mounted on the vehicle that is autonomous.

18. A non-transitory computer-readable program storage medium having instructions stored thereon, the instructions, when executed by a processor, causing the processor to compensate radar measurement of a vehicle by performing a method comprising:
generating a set of velocity hypotheses of a target object based on a first measurement data obtained from sensors mounted on the vehicle;
generating cluster velocity estimates by applying a clustering algorithm to a second measurement data obtained from the sensors; and
providing one or more selected velocity hypotheses from the set of velocity hypothesis as compensated radar measurement data of the target object based on the cluster velocity estimates.

19. The non-transitory computer-readable program storage medium of claim 18, wherein the generating of the cluster velocity estimates comprises:
applying the clustering algorithm to cluster points in a frame provided as the second measurement data; and
applying a tracking algorithm to each cluster to generate the cluster velocity estimates.

20. The non-transitory computer-readable program storage medium of claim 18, wherein the method further comprises: determining scores of each velocity hypothesis based on the cluster velocity estimates.
